(19) United States
(12) Patent Application Publication
(10) Pub. No.: US 2003/0017298 A1
(43) Pub. Date: Jan. 23, 2003

(54) Floating device

(76) Inventor: Zhi-Mao Chang, Taichung (TW)

Correspondence Address: Zhi-Mao Chang, 58, MA YUAN WEST ST., TAICHUNG, TW

(21) Appl. No.: 09/910,620

(22) Filed: Jul. 20, 2001

(51) Int. Cl. B32B 1/04

(52) U.S. Cl. 428/76

(57) ABSTRACT

A life jacket has two floating devices. Each of the floating devices has an expandable polystyrene layer, an ethylene/vinyl acetate copolymer layer enclosing the expandable polystyrene layer, and a fabric casing enclosing the ethylene/vinyl acetate copolymer layer.

### BACKGROUND OF THE INVENTION

The present invention relates to a floating device. More particularly, the present invention relates to a floating device which contains at least two kinds of floating materials.

A conventional floating device has a pocket and a single floating material such as an expandable polystyrene, an ethylene/vinyl acetate copolymer, and a polyurethane. The pocket and the floating material are sewed together. Since the expandable polystyrene is fragile, the expandable polystyrene will be fractured while bumping. However, the expandable polystyrene has a good floating property. The The floating property of ethylene/vinyl acetate copolymer is inferior to the floating property of the expandable polystyrene. The price of the polyurethane is higher than the price of the expandable polystyrene. Since the pocket and the floating material are sewed together, a thread is easily broken after a long period of usage.

### SUMMARY OF THE INVENTION

An object of the present invention is to provide a floating device which contains at least two kinds of floating materials without sewing.

Accordingly, a floating device comprises a first floating layer, a second floating layer enclosing the first floating layer, and a fabric casing enclosing the second floating layer.

### BRIEF DESCRIPTION OF THE DRAWINGS

FIG. 1 is a perspective view of a life jacket having two floating devices of a preferred embodiment in accordance with the present invention;

FIG. 2 is a sectional view taken along line 2R-2R in FIG. 1;

FIG. 3 is a perspective view of a floating board of a preferred embodiment in accordance with the present invention; and

FIG. 4 is a sectional view taken along line 4P-4P in FIG. 3.

### DETAILED DESCRIPTION OF THE INVENTION

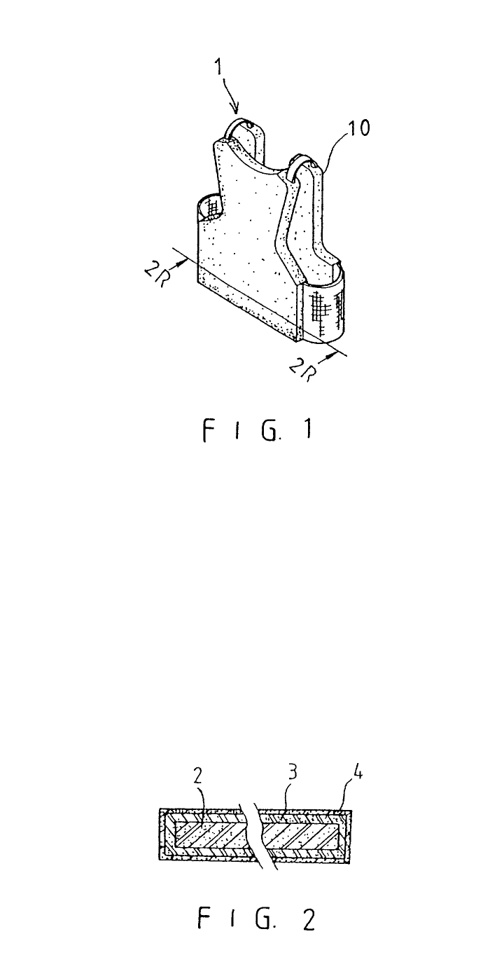

Referring to FIGS. 1 and 2, a life jacket 1 has two floating devices 10.

Each of the floating devices 10 comprises an expandable polystyrene layer 2, an ethylene/vinyl acetate copolymer layer 3 enclosing the expandable polystyrene layer 2, and a fabric casing 4 enclosing the ethylene/vinyl acetate copolymer layer 3.

The expandable polystyrene layer 2 and the ethylene/vinyl acetate copolymer layer 3 are adhered together under a high pressure and a high temperature.

The fabric casing 4 and the ethylene/vinyl acetate copolymer layer 3 are adhered together under the high pressure and the high temperature also.

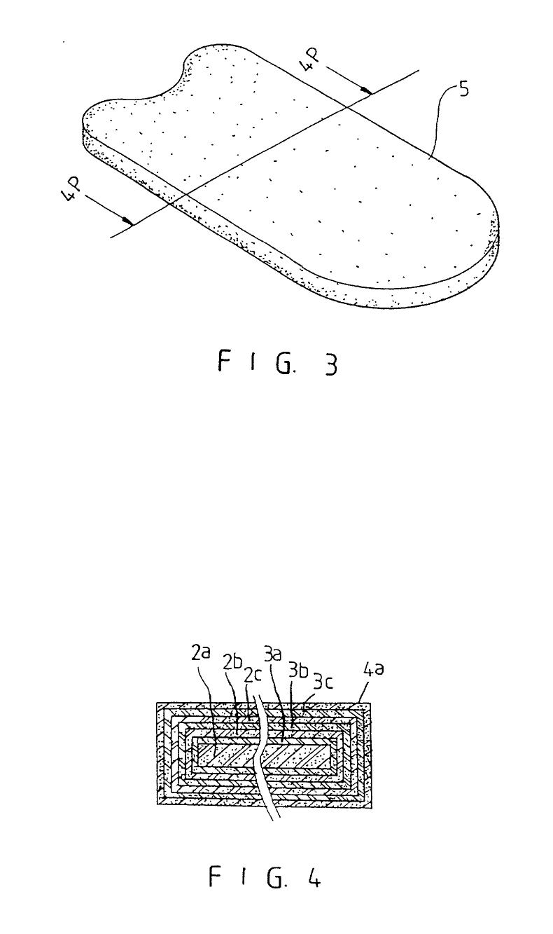

Referring to FIGS. 3 and 4, a floating board 5 comprises a first expandable polystyrene layer 2a, a first ethylene/vinyl acetate copolymer layer 3a enclosing the first expandable polystyrene layer 2a, a second expandable polystyrene layer 2b enclosing the first ethylene/vinyl acetate copolymer layer 3a, a second ethylene/vinyl acetate copolymer layer 3b enclosing the second expandable polystyrene layer 2b, a third expandable polystyrene layer 2c enclosing the second ethylene/vinyl acetate copolymer layer 3b, a third ethylene/vinyl acetate copolymer layer 3c enclosing the third expandable polystyrene layer 2c, and a fabric casing 4a enclosing the third ethylene/vinyl acetate copolymer layer 3c.

The invention is not limited to the above embodiment but various modification thereof may be made. Further, various changes in form and detail may be made without departing from the scope of the invention.

I claim:

1. A floating device comprises:
a first floating layer,
a second floating layer enclosing the first floating layer, and
a fabric casing enclosing the second floating layer.

2. The floating device as claimed in claim 1, wherein the first floating layer is made of an expandable polystyrene layer material, and the second floating layer is made of an ethylene/vinyl acetate copolymer material.
